(19) United States
(12) Patent Application Publication
(10) Pub. No.: US 2016/0370637 A1
(43) Pub. Date: Dec. 22, 2016

(54) TRANSPARENCY VARIABLE GLASS AND APPARATUS OF CONTROLLING TRANSPARENCY OF THE SAME

(71) Applicant: Hyundai Motor Company, Seoul (KR)

(72) Inventor: Sung Woo Lee, Anyang (KR)

(21) Appl. No.: 14/960,353

(22) Filed: Dec. 5, 2015

(30) Foreign Application Priority Data
Jun. 19, 2015 (KR) 10-2015-0087568

(51) Int. Cl. G02F 1/137; G02F 1/133; G02F 1/1334

(52) U.S. Cl. CPC G02F 1/13731; G02F 1/13342; G02F 1/13306; G02F 2001/13756

(57) ABSTRACT

A transparency variable glass that adjusts a transmittance of incident light and a transparency control apparatus is provided. The transparency variable glass includes a transmissive layer encapsulated between a first and second transparent plate. A plurality of polymers are mixed which react to the same electric field. A dye doped polymer changes an initial transmittance and a color is used as one of the polymers..

### CROSS-REFERENCE TO RELATED APPLICATION

This application claims under 35 U.S.C. §119(a) the benefit of Korean Patent Application No. 10-2015-0087568 filed on Jun. 19, 2015, the entire contents of which are incorporated herein by reference.

### BACKGROUND

### (a) Technical Field

The present disclosure relates to a transparency variable glass and more particularly, (to a transparency variable glass) which adjusts transmittance of incident light and an apparatus of controlling transparency of the same.

### (b) Background Art

Recently, a variable transparency switching window (VTSW) that is applied to a glass including a front glass of a vehicle or a sun roof of a vehicle may switch transmittance by adjusting a voltage based on transparency. A transparency variable glass of the related art to which the VTSW technology is applied includes a transmissive layer that adjusts (e.g., switches) a glass transmittance based on a user selection of a user. Accordingly light transmissivity and an optical characteristic are adjusted in response to power applied to a supply electrode terminal via a plurality of power supplying electrodes. The above information disclosed in this section is merely for enhancement of understanding of the background of the invention and therefore it may contain information that does not form the prior art that is already known in this country to a person of ordinary skill in the art.

### SUMMARY

The present invention has provides a transparency variable glass in which a transmissive layer may be encapsulated between a plurality of glasses and a plurality of polymers may be mixed which react at the same electric field. Further, a dye doped polymer may adjust an initial transmittance and a color may be used as one of the polymers and may include an apparatus of controlling transparency of the same.

In one aspect, a transparency variable glass may include a first transparent plate having a first electrode disposed on a surface and a second transparent plate having a second electrode disposed on a surface adjacent to the first electrode. Further, a variable transmissive layer may include a polymer structure formed by a first polymer and a second polymer and filled between the first transparent plate and the second transparent plate. A light transmissivity may be based on a change of an electric field formed between the first electrode and the second electrode.

Specifically, the first polymer may be a dye doped polymer which has about the same level of phase change at the same electric field as the second polymer. The second polymer may be a liquid crystal polymer or a transparent polymer. For example, the first and second polymers may have a plurality of phase changes based on the change of the electric field formed between the first and second electrodes. The variable transmissive layer may have an initial transmittance based on density change of the first polymer. According to an exemplary embodiment, the variable transmissive layer may have a color based on a color of the first polymer.

In another aspect, an apparatus of controlling transparency of a transparency variable glass may include the transparency variable glass, a power supply configured to supply a voltage to the transparent variable glass and a controller configured to adjust the transmittance of the transparency variable glass by adjusting (e.g., changing) a voltage that may be supplied to the transparency variable glass. Further a memory may be configured to provide data of a lookup table to the controller. For example, the lookup table may determine a voltage value (e.g., voltage values which are applied to the first and second electrodes) to adjust a transmittance of the transparency variable glass. Accordingly, a variable transmissive layer may be formed by mixing two polymers that may react to the same electric field. A dye doped polymer may be used as one of the polymers, thereby setting an initial transmittance and a color of the transparency variable glass.

### BRIEF DESCRIPTION OF THE DRAWINGS

The above and other features of the present invention will now be described in detail with reference to certain exemplary embodiments thereof illustrated in the accompanying drawings:

FIG. 1 is an exemplary transparency control apparatus of a transparency variable glass according to an exemplary embodiment of the present invention;

FIG. 2 is an exemplary cross-sectional view of a transparency variable glass according to an exemplary embodiment of the present invention;

FIG. 3 is an exemplary view illustrating a phase change of a variable transmissive layer within a transparency variable glass according to an exemplary embodiment of the present invention;

FIGS. 4A-4B are exemplary conceptual views illustrating an operating state of a transparency variable glass according to exemplary embodiments of the present invention;

FIGS. 5A -5B are exemplary graphs illustrating an indoor temperature change of a vehicle based on whether a transparency variable glass according to an exemplary embodiment of the present invention; and

FIG. 6 is an exemplary graph illustrating an initial transmittance based on a dye doped polymer density in a variable transmissive layer of a transparency variable glass according to an exemplary embodiment of the present invention.

Reference numerals set forth in the Drawings includes reference to the following elements as further discussed below.

100: transparency variable glass

110: first transparent plate

120: second transparent plate

130: first electrode

140: second electrode

150: variable transmissive layer

200: power supply

300: controller

400: memory unit (e.g., memory)

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed therebetween.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

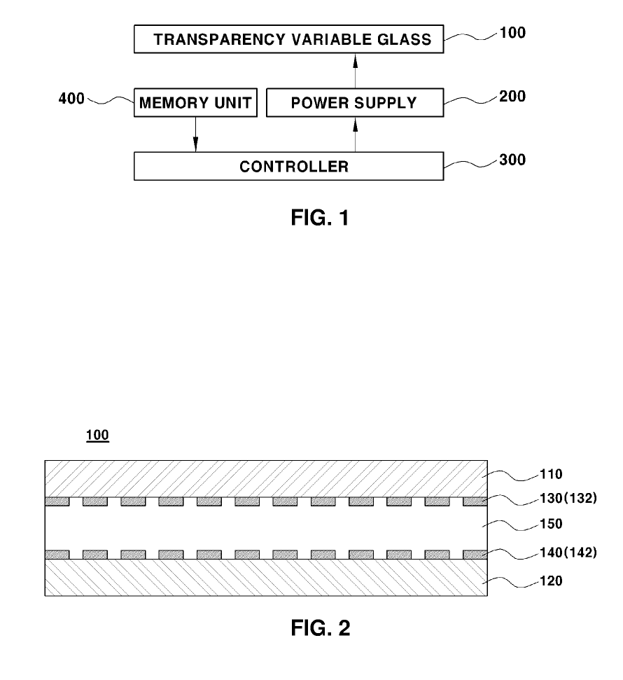

Referring to FIG. 1, a glass transparency control apparatus according to an exemplary embodiment may include a transparency variable glass 100, a power supply 200, a controller 300, and a memory 400. The transparency of the transparency variable glass 100 may be adjusted based on a user selection. Further, the transparency variable glass 100 has a light transmissivity that may be based on a change (e.g., an adjustment) of an electric field formed between electrodes 130 and 140 therein. Additionally, the light transmissivity may be variably adjusted based on a voltage source that may be applied to the electrodes 130 and 140 therein.

The power supply 200 may be configured to supply a voltage to the transparency variable glass 100 and may be operated by the controller 300 to supply a voltage. In other words, the controller 300 may be configured to supply a voltage based on data of a lookup table stored in the memory unit 400. The controller 300 maybe configured to adjust a voltage applied from the power supply 200 to the transparency variable glass 100 based on information of transparency selected by the user to adjust the transparency and transmittance of the transparency variable glass 100. Further, the controller may be configured to apply a voltage with a level selected from a plurality of levels to implement multiple levels of transmittance of the transparency variable glass 100 in various ways.

The memory 400 may be configured to store a lookup table drawn and generated by prior experiment and evaluation and may provide data of the lookup table to the controller 300 that receives user selection may be configured to adjust the voltage. Accordingly, a response speed at which a transmittance occurs may be adjusted based on the user selection of the user may be minimized. The lookup table provides a data table when a voltage value is supplied to the transparency variable glass 100 may be set in accordance with a transparency or a gray level of the transparency variable glass 100. Further, the look up table provides data at a rapid response speed when the transmittance of the transparency variable glass 100 is adjusted. In other word, the lookup table may determine a voltage value to adjust a transmittance of the transparency variable glass 100 and may provide a voltage value that corresponds to user selection information (transmittance) input to the controller 300. Further, the controller 300 may be configured to adjust a voltage applied to the electrodes 130 and 140 of the transparency variable glass 100 based on the input voltage value.

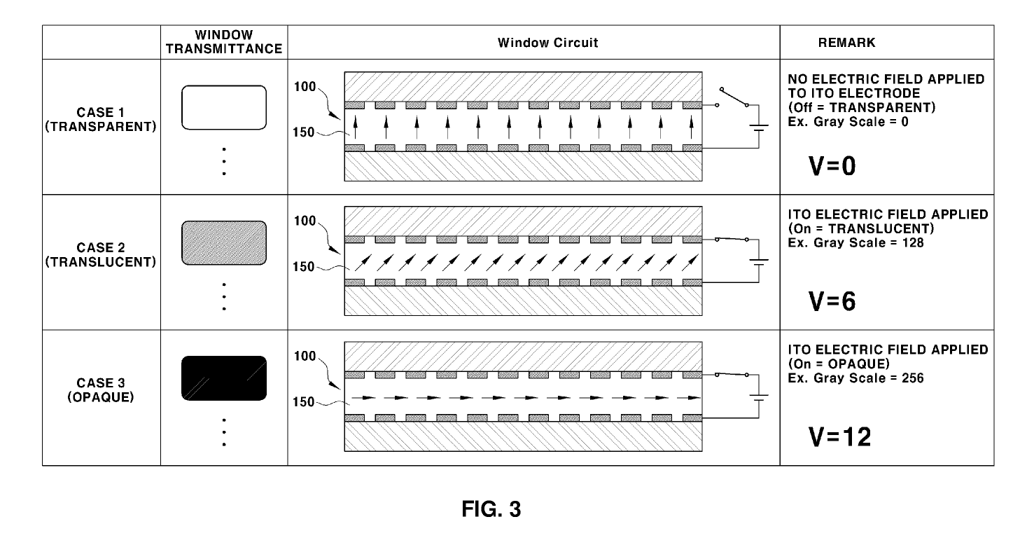

In particular, a structure of the transparency variable glass 100 will be described with reference to FIGS. 2 and 3. As illustrated in FIG. 2, the transparency variable glass 100 may include a first transparent plate 110, a second transparent plate 120, and a variable transmissive layer 150. The first and second transparent plates 110 and 120 may be formed of a plate-shaped transparent material and may be disposed on and below the transparency variable glass 100. The first electrode 130 and a second electrode 140 which apply a voltage may be integrally formed on inner surfaces of the first and second transparent plates 110 and 120.

Further, the transparent plates 110 and 120 may be a light transmissive inorganic substrate, organic substrate or a plate laminated by the same or different substrates. For example, the substrate may be a plastic plate selected from a group consisting of glass, quartz, polyethylene terephthalate (PET), polyethylene naphthalate (PEN), polyimide (PI), polycarbonate (PC), polystylene (PS), polyoxyethylene (POM), acrylonitrile styrene copolymer (AS resin), and triacetyl cellulose (TAC). The first electrode 130 and the second electrode 140 may have substantially similar light transmissivity as an indium tin oxide (ITO) layer, a fluorinated tin oxide (FTO) layer, an indium zinc oxide (IZO) layer, an Al-doped zinc oxide (AZO) layer, a zinc oxide (ZnO) layer, and an indium zinc tin oxide (IZTO) layer.

The variable transmissive layer 150 may be formed in a polymer structure by (e.g., mixing) a first polymer and a second polymer and may be filled between the first transparent plate 110 and the second transparent plate 120. Accordingly, the transmissive layer 150 may have light transmissivity based on a change of an electric field formed between the first electrode 130 and the second electrode 140 positioned adjacent to each other. Specifically, the first polymer may be a dye processed polymer (hereinafter, referred to as a dye doped polymer) having a function as a polarizer and may adjust circular polarization to be linear polarization. Further, the first polymer may have light transmissivity based on change of an electric field. Since the variable transmissive layer 150 may polarize incident light by the contained first polymer when power is not applied, the transmittance of the transparency variable glass may be improved compared to the transmissive layer that does not contain the first polymer.

The second polymer may be any one selected from a liquid crystal polymer and a transparent polymer having light transmissivity based on the change of the electric field. For example, the transparent polymer may be a holographic polymer that has a plurality of phases based on the change of the electric field formed between the electrodes 130 and 140 by the voltage applied to the transparency variable glass 100. Therefore, phase change thereof may be formed at multiple levels based on the applied voltage.

The dye doped polymer may include a polymer obtained by processing a dye on a polymer have a phase adjusted in response to the electric field. Further, a phase change may be the same as or similar to the phase change of the liquid crystal polymer or a transparent polymer in accordance with the applied voltage. In other words, the first polymer contained in the variable transmissive layer may have the same level of phase change as the second polymer at the same electric field. The first polymer and the second polymer may react at the about same electric field to simultaneously implement the same or similar phase difference. When an electric field is formed between the electrodes of the transparency variable glass, the polymer may have a polarizing property to adjust a phase of the incident light and may transmit the incident light.

Referring to FIG. 3, when the transparency variable glass 100 implements a predetermined transmittance between an initial transmittance in the most transparent state and a final transmittance in the most opaque state, the first and second polymers of the variable transmissive layer 150 may exhibit a predetermined phase between a vertical state and a horizontal state. For example, based on a voltage applied to both ends, when the first and second polymers have a vertical phase, the variable transmissive layer 150 may change a light incident from the exterior by about 0°. When the first and second polymers have an inclined phase (e.g., an intermediate state between the vertical state and the horizontal state), the variable transmissive layer 150 may change the light incident from the exterior by approximately 45°. Further, when the first and second polymers have a horizontal phase, the variable transmissive layer 150 may change the light incident from the exterior by approximately 90°.

As described above, the transparency variable glass 100 may implement various light transmissivity in accordance with the applied voltage, based on the electric field that may be applied to the variable transmissive layer 150 and may be configured to adjust the transparency and transmittance. When the voltage is applied between the first electrode 130 and the second electrode 140, the light transmissivity may be reduced, and the first and second polymers of the variable transmissive layer 150 may be relatively opaque. Accordingly, as an increased voltage may be applied, the light transmissivity may be reduced.

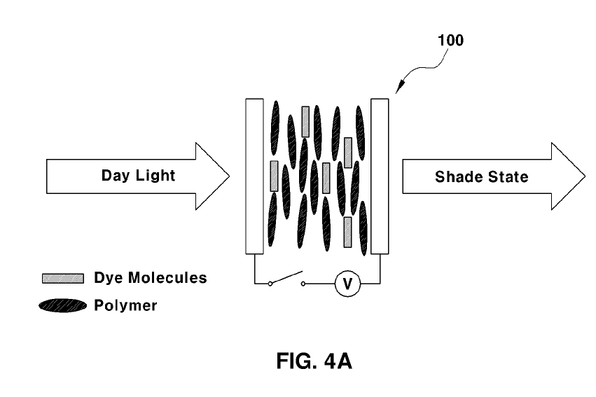

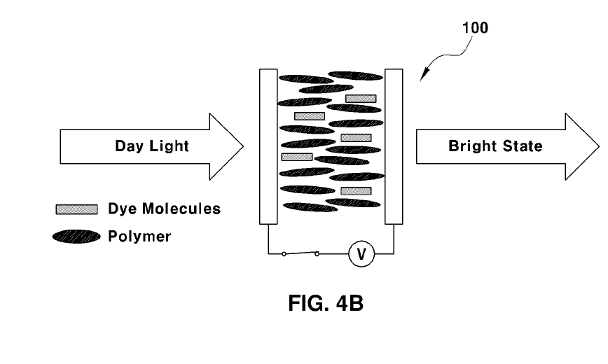

As illustrated in FIGS. 4A and 4B, when day light is incident, voltage may not be applied between the first electrode 130 and the second electrode 140, the variable transmissive layer 150 may be in a shade state thereby shielding the light. When the voltage is applied, the variable transmissive layer 150 may in brightened or illuminated state. Accordingly, the phases of the first and second polymers may be adjusted, thereby transmitting the light. For example, the transparency variable glass 100 may use the variable transmissive layer 150 to shield light by adjusting the transmittance via the voltage variation. In other words, when the transparency variable glass 100 is applied to a vehicle glass, the transparency variable glass 100 may be applied to adjust an interior temperature of the vehicle and may improve the in-vehicle environmental (e.g., temperature) and energy control performance.

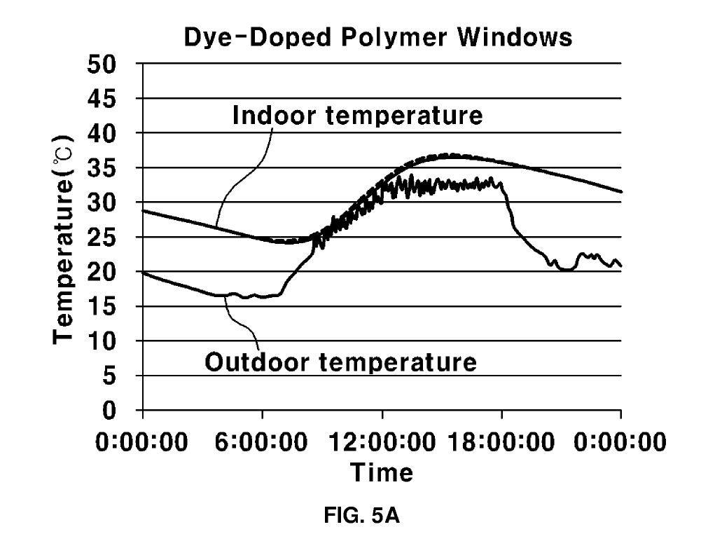

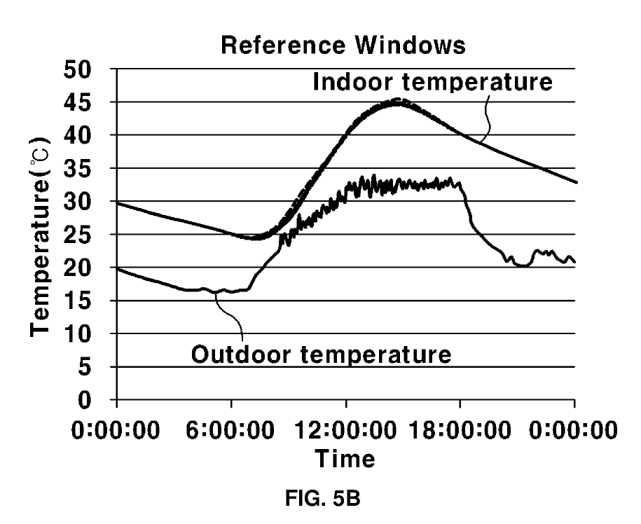

As illustrated in FIGS. 5A-5B, the interior temperature of the vehicle which employs the transparency variable glass 100 may be reduced compared to the interior temperature of a vehicle which does not use the transparency variable glass. When a variable color dye is used as a dye applied to the first polymer (a dye doped polymer), the variable transmissive layer 150 may have a color based on the color of the first polymer.

Included within the variable color dye, are a plurality of dyes having various colors such as blue, red, and green that may be used and the variable transmissive layer may contain the first polymer. For example the first polymer may use the variable color dye having a color based on the color of the first polymer in a shade state. The transparency and transmittance of the variable transmissive layer 150 may vary by changing the density of the first polymer. Since the first polymer has a function as a polarizer even when voltage is not applied to the electrodes 130 and 140, may be different from the second polymer. In particular, the initial transmittance (e.g., transmittance in a state where no voltage is applied) may be changed and set by adjusting the density of the first polymer in the variable transmissive layer 150 while manufacturing the variable transmissive layer 150. In other words, the variable transmissive layer 150 has an initial transmittance based on change of density of the contained first polymer.

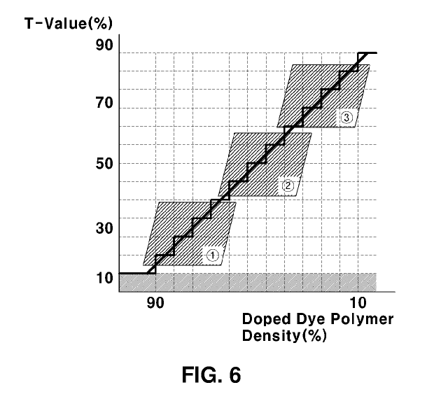

Therefore, as illustrated in FIG. 6, the transmittance and a transparency switching range of the transparency variable glass 100 may be determined based on the initial transmittance determined based on the density of the first polymer in the variable transmissive layer 150, as indicated by (1), (2), and (3). In other words, when the initial transparency (e.g., the initial transmittance) is determined by the first polymer, the transmittance of the transparency variable glass 100 may be adjusted within a predetermined range based on a voltage value applied at both ends of the variable transmissive layer 150. Further, the transmittance adjustment based on phase control of the variable transmissive layer 150 when the voltage is adjusted may be identically applied regardless of the initial transmittance.

Since the variable transmissive layer 150 may be formed by mixing the first and second polymers, the variable transmissive layer 150 may have a high viscosity. The direct current (DC) power may be used without being adjusted. Therefore, the voltage sources applied from the power supply 200 may control a phase of the variable transmissive layer 150 regardless of a type of alternating current (AC) and direct current (DC). Furthermore, transmittance of a portion of the transparency variable glass 100 may be adjusted to be partially changed.

Referring to FIG. 2, as an exemplary embodiment, at least one of the first and second electrodes 130 and 140 may be configured as a plurality of sub electrodes 132 and 142 to which individual voltages are applied. The voltage may be individually applied to a portion of the transparency variable glass 100 to selectively adjust a transmittance of a portion of the transparency variable glass by an electric field formed between components to which the individual voltages may be applied.

The transparency variable glass according to the exemplary embodiment of the present invention may be applied to a product such as a windshield glass or a sunroof of the vehicle and a window or a door of a building to achieve visual improvement (e.g., color) and environmental improvement (e.g., a temperature). In particular, when the transparency variable glass may be applied to a display or window product that may use a polarizer, transmittance may be significantly improved. The transparency variable glass of the exemplary embodiment may be applied to various fields including home appliances, display products, and other glass applied product such as glasses or a helmet.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A transparency variable glass, comprising:
a first transparent plate that includes a first electrode disposed on a surface;
a second transparent plate which includes a second electrode disposed on a surface positioned adjacent to the first electrode; and
a variable transmissive layer having a polymer structure formed by a first polymer and a second polymer and filled between the first transparent plate and the second transparent plate and having a light transmissivity based on a change of an electric field formed between the first electrode and the second electrode.

2. The transparency variable glass of claim 1, wherein the variable transmissive layer has an initial transmittance based on a change of density of the first polymer.

3. The transparency variable glass of claim 1, wherein the variable transmissive layer has a color based on a color of the first polymer.

4. The transparency variable glass of claim 1, wherein the first polymer is a dye doped polymer having the same level of phase change at the same electric field as the second polymer.

5. The transparency variable glass of claim 1, wherein the second polymer is a liquid crystal polymer or a transparent polymer.

6. The transparency variable glass of claim 1, wherein the first and second polymers have a plurality of phase changes based on the change of the electric field formed between the first and second electrodes.

7. A transparency control apparatus of a transparency variable glass, comprising:
a transparency variable glass of claim 1;
a power supply configured to supply a voltage to the transparency variable glass; and
a controller configured to adjust transmittance of the transparency variable glass by adjusting a voltage that is supplied to the transparency variable glass.

8. The transparency control apparatus of claim 7, further comprising:
a memory configured to provide data of a lookup table to the controller,
wherein the lookup table determines a voltage value to adjust a transmittance of the transparency variable glass.

9. The transparency control apparatus of claim 7, wherein the transparency variable glass has a variable transmissive layer having a polymer structure formed by a first polymer and a second polymer and filled between a first transparent plate and a second transparent plate and has a light transmissivity based on a change of an electric field formed between a first electrode disposed on the first transparent plate electrode and a second electrode disposed on the second transparent plate.

10. The transparency control apparatus of claim 9, wherein the variable transmissive layer has an initial transmittance based on a change of density of a first polymer.
